(19) United States
(12) Patent Application Publication
(10) Pub. No.: US 2019/0285208 A1
(43) Pub. Date: Sep. 19, 2019

(54) Cable Protective Device for a Subsea Cable in an Offshore Wind Farm

(71) Applicant: Zhejiang Huayun Ocean Engineering Technology Service Co., Ltd., Hangzhou (CN)

(72) Inventors: Ronghua Zhu, Hangzhou, Zhejiang (CN); Meiyang Zhang, Hangzhou, Zhejiang (CN); Zhenya Tian, Hangzhou, Zhejiang (CN)

(21) Appl. No.: 16/307,940

(22) PCT Filed: Jul. 18, 2016
(86) PCT No.: PCT/CN2016/090332

§ 371 Date: May 7, 2019

(30) Foreign Application Priority Data
Jun. 7, 2016 (CN) 201610402730.3

(51) Int. Cl. F16L 21/06; F16L 23/024; H02G 3/04

(52) U.S. Cl. CPC F16L 21/06; H02G 3/04; F16L 23/024

(57) ABSTRACT

Provided is a cable protection device for subsea cable in offshore wind farm, the cable protection system including: a connecting flange, an intermediate pipe body, a tapered connecting pipe, and a connector. The subsea cable protection device in offshore wind farm has the advantages of simple structure, no segmentation mould making in manufacturing process. During installation and use, the length of the intermediate pipe can be increased or decreased according to actual requirements. Moreover, the cable protection device can be connected to the cable steel tube on the wind turbine foundation via the connecting flange.

### TECHNICAL FIELD

The present disclosure relates to the field of cable protection devices, and in particular to a cable protection device for a subsea cable in an offshore wind farm.

### BACKGROUND ART

With the development of human society, energy consumption is increasingly growing, and the environmental problems caused thereby are also becoming increasingly conspicuous. The importance of clean energy (power) becomes visible accordingly. As a kind of clean energy, wind energy is used more and more popularly. Wind energy can be converted into electrical energy by using a wind power generator (wind turbine), and the converted electrical energy is transmitted into other equipment through a cable. If the cable is damaged, the normal use of the wind power generator will be seriously affected, therefore how to effectively protect the cable is an urgent problem to be solved.

### SUMMARY

In view of this, the present disclosure provides a protection device for a subsea cable in an offshore wind farm, which can effectively protect a cable.

The present disclosure provides the following technical solution:

A protective device for a subsea cable in an offshore wind farm base, which comprises: a connecting flange, an intermediate pipe body, a tapered connecting pipe, and a connector, wherein:

the connecting flange comprises a flange plate and a flange connecting pipe disposed on one side of a plane where the flange plate is located;

the connecting flange is connected to one end of the intermediate pipe body via the flange connecting pipe, and the other end of the intermediate pipe body is connected to the tapered connecting pipe via the connector;

the connector is a pipe body having both ends opened, one end of the connector is disposed inside the other end of the intermediate pipe body and fixedly connected to the intermediate pipe body, and the other end of the connector is disposed inside one end of the tapered connecting pipe and fixedly connected to the tapered connecting pipe.

Further, one end of the flange connecting pipe remote (away) from the flange plate has an outer diameter matching an inner diameter of one end of the intermediate pipe body, and one end of the flange connecting pipe remote from the flange plate is disposed in one end of the intermediate pipe body and fixedly connected to the intermediate pipe body.

Further, one end of the flange connecting pipe remote from the flange plate is provided with a plurality of first through holes, the intermediate pipe body is provided with second through holes matching with the first through holes, and the first through holes and the second through holes allow the connecting flange and the intermediate pipe body to be fixedly connected by a first fastener.

Further, the first through holes are provided with screw threads, the first fastener comprises a plurality of first bolts and a first clip, the first clip is matched with a cross-section shape of the intermediate pipe body, the first clip is provided with through holes, and the first bolts are screwedly engaged with the first through holes and the second through holes to fix the first clip outside the intermediate pipe body, so that the flange connecting pipe is fixedly connected to the intermediate pipe body.

Further, the connector has one end provided with a plurality of third through holes, and the other end provided with a plurality of fourth through holes, the intermediate pipe body is provided with fifth through holes matching with the third through holes, and the third through holes and the fifth through holes allow the intermediate pipe body and the connector to be fixedly connected by a second fastener.

Further, the tapered connecting pipe is provided with sixth through holes matching with the fourth through holes, and the fourth through holes and the sixth through holes allow the connector and the tapered connecting pipe to be fixedly connected by a third fastener.

Further, the tapered connecting pipe comprises a cylindrical pipe portion and a tapered pipe portion, the tapered pipe portion comprises a large end portion and a small end portion, one end of the large end portion is connected to the cylindrical pipe portion, the inner diameter of the small end portion matches the outer diameter of a cable to be protected, and one end of the cylindrical pipe portion remote from the tapered pipe portion has an inner diameter matching with an outer diameter of the connector.

Further, the sixth through holes are provided at one end of the cylindrical pipe portion remote from the tapered pipe portion.

Further, the third through holes and the fourth through holes are provided with screw threads therein, the second fastener comprises a plurality of second bolts and a second clip, the second clip is matched with a cross-section shape of the intermediate pipe body, the second clip is provided with through holes, and the second bolts are screwedly engaged with the third through holes and the fifth through holes to fix the second clip outside the intermediate pipe body, so that the intermediate pipe body is fixedly connected to the connector.

Further, the third fastener comprises a plurality of third bolts and a plurality of third clip, the third clip is matched with a cross-section shape of the cylindrical pipe portion, the third clip is provided with through holes, and the third bolts are screwedly engaged with the fourth through holes and the sixth through holes to fix the third clip outside the tapered connecting pipe, so that the connector is fixedly connected to the tapered connecting pipe.

The subsea cable protection device in offshore wind farm according to the embodiments of the present disclosure has the advantages of simple structure, no segmentation mould making in manufacturing process, whereby the production cost of the subsea cable protection device in offshore wind farm is reduced. During installation and use, the length of the intermediate pipe body may be increased or decreased according to actual requirements, the overall installation is easy and convenient, and the assembly operation of the subsea cable protection device can be completed quickly and efficiently, therefore increasing installation efficiency and saving the installation time and workload. Moreover, the protection device may be connected to cable steel tube on the wind turbine foundation via the connecting flange so as to achieve the protection of the input and output cable of the wind turbine foundation.

### BRIEF DESCRIPTION OF DRAWINGS

In order to more clearly illustrate technical solutions of embodiments of the present disclosure, drawings required for use in the embodiments will be described briefly below. It is to be understood that the drawings below are merely illustrative of some embodiments of the present disclosure, and therefore should not be considered as limiting its scope. It would be understood by those of ordinary skill in the art that other relevant drawings could also be obtained from these drawings without any inventive effort.

FIG. 1 is a schematic structural diagram showing the connection between a protection device for a subsea cable in an offshore wind farm and an 15 type steel pipe on wind turbine foundation according to an embodiment of the present disclosure.

FIG. 2 is a schematic structural diagram of a protection device for a subsea cable in an offshore wind farm according to an embodiment of the present disclosure.

FIG. 3 is a schematic cross-section structural diagram of a connector part of a protection device for a subsea cable in an offshore wind farm according to an embodiment of the present disclosure.

FIG. 4 is a schematic structural diagram of a connector of a protection device for a subsea cable in an offshore wind farm according to an embodiment of the present disclosure.

FIG. 5 is a schematic structural diagram of a connecting flange of a protection device for a subsea cable in an offshore wind farm according to an embodiment of the present disclosure.

FIG. 6 is a schematic structural diagram of an intermediate pipe body of a protection device for a subsea cable in an offshore wind farm according to an embodiment of the present disclosure.

FIG. 7 is a schematic structural diagram of a tapered connecting pipe of a protection device for a subsea cable in an offshore wind farm according to an embodiment of the present disclosure.

FIG. 8 is a schematic structural diagram of a first clip of a protection device for subsea cable in an offshore wind farm according to an embodiment of the present disclosure.

Here, reference numerals are summarized as follows:

offshore wind farm subsea cable protection device 100; 15 type steel pipe 200; cable 300; connecting flange 101; intermediate pipe body 102; tapered connecting pipe 103; connector 104; first fastener 105; second fastener 106; third fastener 107; flange plate 1011; flange connecting pipe 1012; first through hole 1013; second through hole 1021; fifth through hole 1022; sixth through hole 1031; cylindrical pipe portion 1032; tapered pipe portion 1033; third through hole 1041; fourth through hole 1042; first clip 1051; first bolt 1052; second clip 1061; second bolt 1062; third clip 1071; third bolt 1072.

### DETAILED DESCRIPTION OF EMBODIMENTS

In order to make the objects, technical solutions, and advantages of the embodiments of the present disclosure more clear, the technical solutions of the embodiments of the present disclosure will be described below clearly and completely with reference to the accompanying drawings. It is apparent that the embodiments to be described are some, but not all of the embodiments of the present disclosure.

Thus, the following detailed description of the embodiments of the present disclosure is not intended to limit the scope of the present disclosure as claimed, but is merely representative of some embodiments of the present disclosure. All the other embodiments obtained by those of ordinary skill in the art in light of the embodiments of the present disclosure without inventive efforts would fall within the scope of the present disclosure as claimed.

It should be noted that the embodiments in the present disclosure and the features in the embodiments may be combined with one another without conflict.

It should be noted that similar reference numerals and letters refer to similar items in the following figures, and thus once an item is defined in one figure, it may not be further defined or explained in the following figures.

In the description of the present disclosure, it should be noted that orientation or positional relationships indicated by the terms such as “up” and “down” are orientation or positional relationships shown based on the figures, or orientation or positional relationships in which the inventive product is conventionally placed in use, or orientation or positional relationships conventionally understood by those skilled in the art, and such terms are intended only to facilitate the description of the present disclosure and simplify the description, but not intended to indicate or imply that the referred devices or elements must be in a particular orientation or constructed or operated in the particular orientation, and therefore should not be construed as limiting the present disclosure. In addition, terms such as “first” and “second” are used for distinguishing the description only, and should not be understood as an indication or implication of relative importance. The present disclosure will be described in further detail below by way of embodiments and with reference to the accompanying drawings.

With the strong support of the states to offshore wind power, offshore wind farm shows an explosive development. While the offshore wind farm is developing rapidly, it is facing a series of new problems, especially the damage of subsea cables. According to statistics from a European institution, although currently the failure rate of subsea cables for offshore wind power is not the highest, the losses caused by subsea cables have accounted for a large proportion, and the protection of subsea cables has become an urgent problem to be solved.

At present, the protection of a subsea cable, in domestic and foreign, is carried out by using a sectioned Hough structure. Due to the structure or transportation requirements, the length of each segment is in most controlled within 1 meter, thus the installation is time-consuming and laborious, and the cost is high. In addition, since a large number of connectors are required, the failure rate of the protection of the subsea cable is increased to some extent.

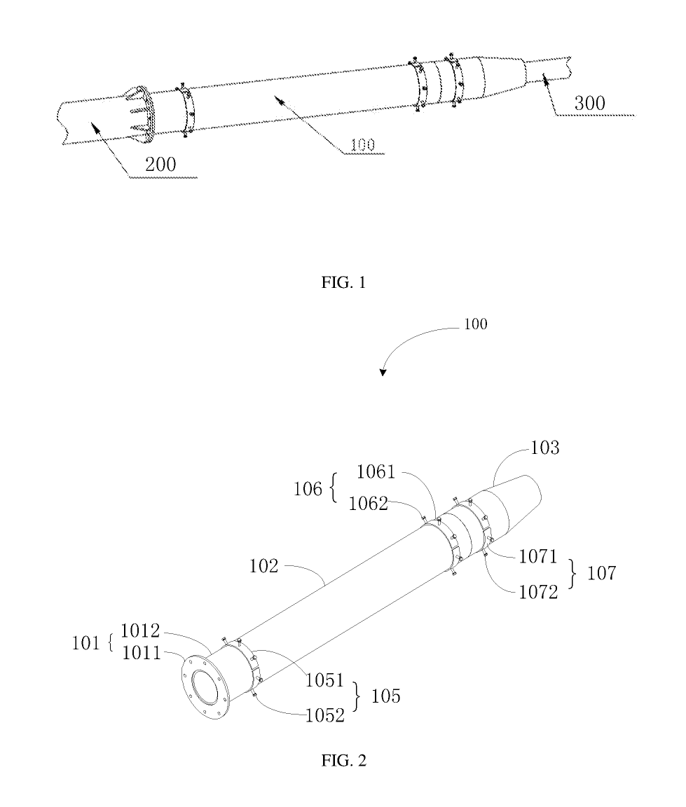

In view of this, FIG. 1 shows a schematic structural diagram showing the connection between a protection device for subsea cable in an offshore wind farm and a cable 300, as well as an 15 type pipe 200, which is a protection tube for subsea cable, according to an embodiment of the present application. In the figure, the 15 type pipe 200 which is a protection tube for subsea cable may lead off from wind turbine foundation, and the cable 300 penetrates therein from one end of the 15 type pipe 200, and penetrates there out from the other end of the subsea cable protection device 100.

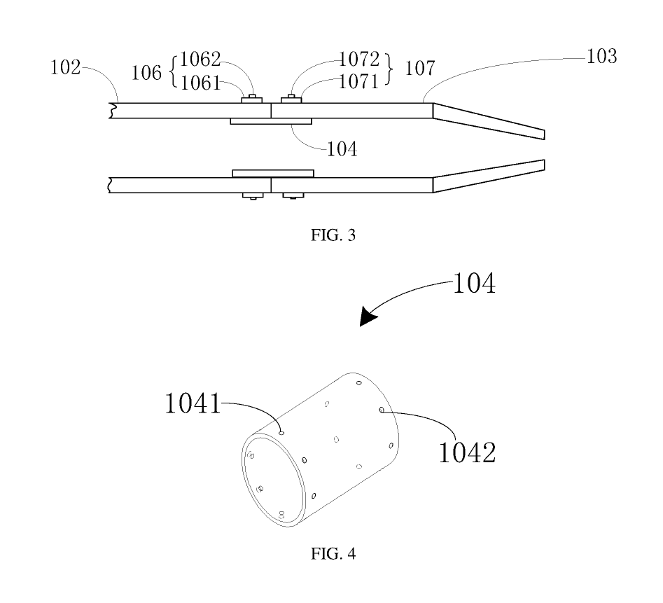

As shown in FIG. 2, FIG. 3, and FIG. 4 which show an offshore wind farm subsea cable protection device 100 according to an embodiment of the present application, the protection device for subsea cable in offshore wind farm comprises: a connecting flange 101, an intermediate pipe body 102, a tapered connecting pipe 103, and a connector 104.

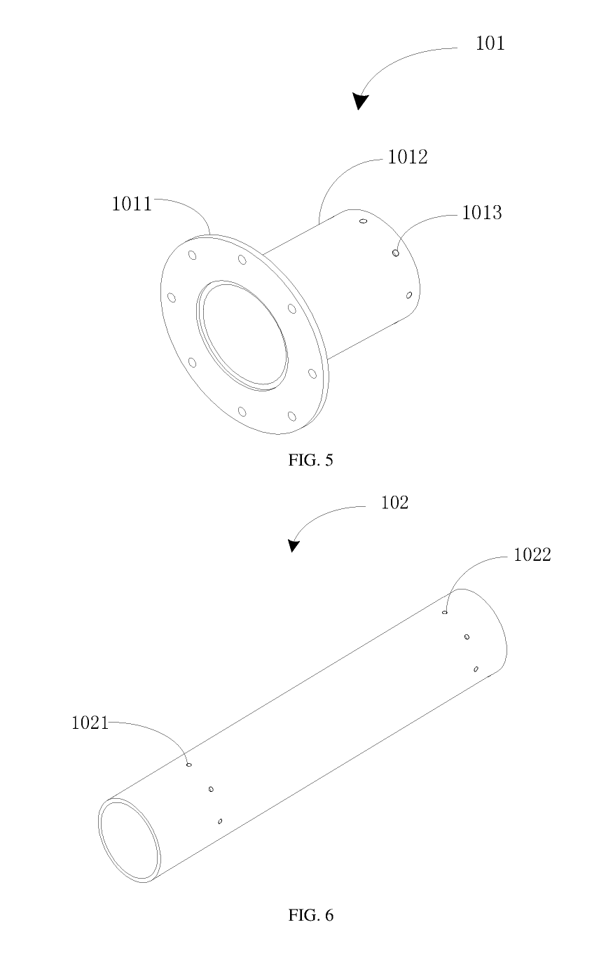

As shown in FIG. 5, the connecting flange 101 comprises a flange plate 1011 and a flange connecting pipe 1012 disposed on one side of a plane where the flange plate is located. the protection device 100 for subsea cable in offshore wind farm in the embodiment of the present disclosure can be applied to the protection of a cable of a wind farm. Electric energy generated by the wind turbine is transmitted through the cable 300. The cable 300 of the offshore wind farm is generally protected by “I” and “J”-shaped steel tube conduits on a wind turbine foundation and by means of deeply burying the cable, however the cable 300 is suspended and is easily damaged by the action of waves and surges due to the reasons such as seafloor scouring. If the present cable protection method is employed, the 15 type steel tube on the wind turbine foundation may connect the connecting flange 101 to a conduit on the wind turbine foundation via the flange plate 1011, and the cable 300 in offshore wind farm can be protected inside the protection device 100 for subsea cable in offshore wind farm to effectively prevent the damage of the cable even in the event of serious scouring.

The size of the flange plate 1011 of the connecting flange 101 and the inner diameter dimension of the flange connecting pipe 1012 may be set according to the actual thickness of the cable 300. It can be understood that the protection device 100 for subsea cable in offshore wind farm according to the embodiment of the present disclosure can be applied not only in the protection of the cable of the wind power generator, but also in other occasions where cable protection is required. Moreover, the protection device 100 for subsea cable in offshore wind farm can not only protect different power transmission cables, but also protect other forms of cables such as optical cables.

The connecting flange 101 is connected to one end of the intermediate pipe body 102 via the flange connecting pipe 1012, and the other end of the intermediate pipe body 102 is connected to the tapered connecting pipe 103 via the connector 104. The connecting flange 101 may have one end connected to the wind turbine base via the flange plate 1011, and the other end connected to the intermediate pipe body 102 via the flange connecting pipe 1012. The intermediate pipe body 102 in the embodiment of the present application is a hollow pipe body, and its specific length may be adjusted according to actual usage requirements.

As shown in FIG. 3 and FIG. 4, the connector 104 is a pipe body having both ends opened, one end of the connector 104 is disposed inside the other end of the intermediate pipe body 102 and fixedly connected to the intermediate pipe body 102, and the other end of the connector 104 is disposed inside one end of the tapered connecting pipe 103 and fixedly connected to the tapered connecting pipe 103. In an embodiment of the present application, the connecting flange 101 is connected to one end of the intermediate pipe body 102, and the tapered connecting pipe 103 is connected to the other end of the intermediate pipe body 102 via the connector 104, so that an integrated protection device 100 for subsea cable in offshore wind farm is formed.

In actual construction and use, the tapered connecting pipe 103, the connector 104, the intermediate pipe body 102, and the connecting flange 101 may be sequentially installed around (on) the cable, and the inner diameters of these components may be matched with the diameter of the actual cable 300, and after the assembly is completed, the flange plate 1011 of the connecting flange 101 is connected and fixed to the conduit on the wind turbine base, such that the installation of the protection device 100 for subsea cable in offshore wind farm is completed. If the protection device 100 for subsea cable in offshore wind farm with different lengths are required, the length of the intermediate pipe body 102 may be increased or decreased for convenient use. The flange plates 1011 at two ends of two protection device 100 for subsea cable in offshore wind farm may also be connected to form a protection device 100 for subsea cable in offshore wind farm with a longer length.

Further, one end of the flange connecting pipe 1012 remote from the flange plate 1011 has an outer diameter matching an inner diameter of one end of the intermediate pipe body 102, and one end of the flange connecting pipe 1012 remote from the flange plate 1011 is disposed in one end of the intermediate pipe body 102 and fixedly connected to the intermediate pipe body 102.

When the connecting flange 101 in the embodiment of the present application is to be connected to the intermediate pipe body 102, the flange connecting pipe 1012 may be inserted into the intermediate pipe body 102. Preferably, the outer diameter of the flange connecting pipe 1012 may be set to be equal to the inner diameter of the intermediate pipe body 102, or the outer diameter of the flange connecting pipe 1012 may be set to be slightly smaller than the inner diameter of the intermediate pipe body 102 for the convenience of installation. In the installation, the flange connecting pipe 1012 having an outer diameter smaller than or equal to the inner diameter of the intermediate pipe body 102 can be introduced into the intermediate pipe body 102, and then the fixed connection there between is completed by other components.

Further, as shown in FIG. 5 and FIG. 6, the flange connecting pipe 1012 is provided with a plurality of first through holes 1013, the intermediate pipe body 102 is provided with second through holes 1021 matching the first through holes 1013, and the first through holes 1013 and the second through holes 1021 are connected by a first fastener 105 to fixedly connect the connecting flange 101 and the intermediate pipe body 102. The positions where the first through holes 1013 are provided may be any positions on the flange connecting pipe 1012, and the number of the holes provided may be determined as required. In general, the first through hole 1013 is provided at one end of the flange connecting pipe 1012 remote from the flange plate 1011, and a plurality of first through holes 1013 are provided in a cross-section plane of the flange connecting pipe 1012. The positions on the intermediate pipe body 102 where the second through holes 1021 are provided may be determined according to the positions where the first through holes 1013 are provided. Since the flange connecting pipe 1012 may be entirely introduced into the interior of the intermediate pipe body 102 in the installation and use, an end portion of the intermediate pipe body 102 may be brought into contact with the flange plate 1011.

In order to fix the intermediate pipe body 102 and the flange connecting pipe 1012, the first through holes 1013 are provided with screw threads, the first fastener 105 comprises a plurality of first bolts 1052 and a first clip 1051, the first clip 1051 is matched with a cross-section shape of the intermediate pipe body 102, the first clip 1051 is disposed outside the intermediate pipe body 102, and the first bolts 1052 are screwedly engaged with the first through holes 1013 to fix the first clip 1051 outside the intermediate pipe body 102. The first through holes 1013 and the second through holes 1021 may be sized as through holes with the same size, and their positions are matched with each other, and a screw thread is provided in advance in the first through hole. The first clip 1051 has a shape matching the cross-section shape of the intermediate pipe body 102, and may be disposed as a circular ring, or the first clip may be disposed as a part of a circular ring for the convenience of installation, and the fixed connection may be completed by a plurality of first clips 1051.

The first clip 1051 is also provided with through holes. During the connection and installation of the flange and the intermediate pipe body 102, the flange connecting pipe 1012 is inserted into the interior of the intermediate pipe body 102, the positions of the first through holes 1013 and the second through holes 1021 are aligned, and then the first clip 1051 is disposed outside the intermediate pipe body 102, and it is ensured that the positions of the through holes in the first clip 1051 are also aligned with the positions of the first through holes 1013 and the second through holes 1021, and then the first bolts 1052 with a matched model are screwed from the outside of the first clip 1051 into the second through holes 1021 and finally into the first through holes 1013 in the flange connecting pipe 1012. In general, the number of the first through holes 1013 and the number of the second through holes 1021 are consistent with each other, and the number of the through holes in all the first clips 1051 is also the same as the number of the first through holes 1013. After all the first bolts 1052 are introduced into the first through holes 1013 through the through holes in the first clip 1051, the connection of the first clip 1051, the intermediate pipe body 102, and the flange connecting pipe 1012 is completed. That is to say, the connecting flange 101 and the intermediate pipe body 102 are connected in one piece.

Further, the connector 104 has one end provided with a plurality of third through holes 1041, and the other end provided with a plurality of fourth through holes 1042, the intermediate pipe body 102 is provided with fifth through holes 1022 matching the third through holes 1041, and the third through holes 1041 and the fifth through holes 1022 allow the intermediate pipe body 102 and the connector 104 to be fixedly connected by a second fastener 106.

Since the two ends of the connector 104 are disposed inside the intermediate pipe body 102 and the tapered connecting pipe 103, respectively, a configuration similar to the above-mentioned first fastener 105 may be disposed when the relevant fixed connection is to be carried out. In general, the length of the connector 104 should be smaller than the length of the intermediate pipe body 102, so that the connector 104 can achieve the connecting effect without affecting the manufacturing cost due to an excessive length. In the embodiment of the present application, upon the respective connections of the connector 104 to the intermediate pipe body 102 and the tapered connecting pipe 103 is completed, the connector 104 is entirely introduced into the interior of the protection device 100 for subsea cable in offshore wind farm, and an end portion of the intermediate pipe body 102 is brought into contact with an end portion of the tapered connecting pipe 103.

In addition, the tapered connecting pipe 103 is provided with sixth through holes 1031 matching the fourth through holes 1042, and the fourth through holes 1042 and the sixth through holes 1031 allow the connector 104 and the tapered connecting pipe 103 to be fixedly connected by a third fastener 107.

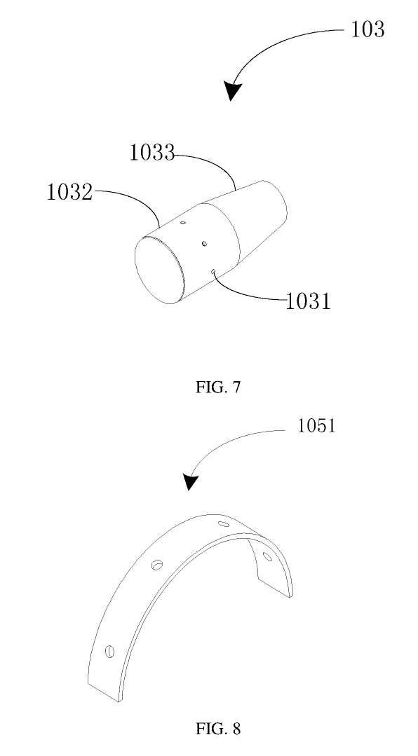

In an embodiment of the present application, as shown in FIG. 7, the tapered connecting pipe 103 comprises a cylindrical pipe portion 1032 and a tapered pipe portion 1033, the tapered pipe portion 1033 comprises a large end portion and a small end portion, the large end portion and the small end portion have different inner diameters, one end of the large end portion is connected to the cylindrical pipe portion 1032, the inner diameter of the small end portion matches the outer diameter of the cable 300 to be protected, and one end of the cylindrical pipe portion 1032 remote from the tapered pipe portion 1033 has an inner diameter matching the outer diameter of the connector 104. The tapered connecting portion comprises two portions having different shapes, the cylindrical pipe portion 1032 mainly achieves the connection with the connector 104, and the tapered pipe portion 1033 is disposed in the shape of a frustum, that is to say, a vertical section of the tapered pipe portion 1033 has an outer shape of a trapezoid, such that after the cable is installed into the protection device 100 for subsea cable in offshore wind farm, the small end portion can be brought into contact with an outer casing of the cable 300 to ensure no entry of other foreign matters into the interior of the protection device 100 for subsea cable in offshore wind farm. The inner diameter of the small end portion may be equal to the outer diameter of the cable 300 or may be slightly smaller than the outer diameter of the cable 300 to prevent entry of foreign matters or marine lives.

Preferably, the sixth through holes 1031 are provided at one end of the cylindrical pipe portion 1032 remote from the tapered pipe portion 1033.

In addition, the third through holes 1041 and the fourth through holes 1042 are provided with screw threads, the second fastener 106 comprises a plurality of second bolts 1062 and a second clip 1061, the second clip 1061 is matched with the cross-section shape of the intermediate pipe body 102, the second clip 1061 is disposed outside the intermediate pipe body 102, and the second bolts 1062 are screwedly engaged with the third through holes 1041 to fix the second clip 1061 outside the intermediate pipe body 102, so that the intermediate pipe body 102 is fixedly connected to the connector 104.

Similarly to the manner in which the first fastener 105 is disposed, the second fastener 106 here also accomplishes the connection of the third through holes 1041 and the fifth through holes 1022 by the second clip 1061 and the second bolts 1062. In the installation and use, one end of the connector 104 provided with the third through holes 1041 is placed inside one end of the intermediate pipe body 102 provided with the fifth through holes 1022, the third through holes 1041 and the fifth through holes 1022 are aligned, and then the second clip 1061 is arranged outside the intermediate pipe body 102 at the position of the fifth through holes 1022, and finally the second bolts 1062 matching the through holes are sequentially passed through the through holes in the second clip 1061, the fifth through holes 1022, and the third through holes 1041, and upon the second bolts 1062 are screwed and installed into all the through holes, the connection of the connector 104 and the intermediate pipe body 102 is completed.

Similarly, the third fastener 107 comprises a plurality of third bolts 1072 and a plurality of third clips 1071, the third clip 1071 is matched with a cross-section shape of the cylindrical pipe portion 1032, and the third bolts 1072 are screwedly engaged with the fourth through holes 1042 and the sixth through holes 1031 to fix the third clip 1071 outside the tapered connecting pipe 103, so that the connector 104 is fixedly connected to the tapered connecting pipe 103.

During the fixing of the connector 104 and the tapered connecting head, similarly, the connector 104 is first placed inside the tapered connecting head, and the fourth through holes 1042 and the sixth through holes 1031 are aligned, the third clip 1071 is disposed outside the tapered connecting head such that the through holes in the third clip 1071 are aligned with the sixth through holes 1031, and then the fourth through holes 1042, the sixth through holes 1031, and the through holes in the third clip 1071 are connected by using the third bolts 1072 in a screwed manner. Upon the installation of all the third bolts 1072 is completed, the fixed connection of the connector 104 to the tapered connecting head is completed. In the first fastener 105, the second fastener 106, and the third fastener 107 in the embodiment of the present application, clips and bolts of the same specifications may be used, and the first clip 1051, the second clip 1061, and the third clip 1071 are of the same specification and all have the same structures as that of the first clip as shown in FIG. 8.

In conclusion, the subsea cable protection device 100 in offshore wind farm according to the embodiments of the present disclosure has the advantages of simple structure, no segmentation mould making in manufacturing process, whereby the production cost of the subsea cable protection device in offshore wind farm is reduced. During installation and use, the length of the intermediate pipe body 102 may be increased or decreased according to actual requirements, the overall installation is easy and convenient, and the assembly operation of the subsea cable protection device can be completed quickly and efficiently, therefore increasing installation efficiency and saving the installation time and workload. Moreover, the protective device may be connected to a cable conduit on a wind power generator via the connecting flange 101 so as to achieve the protection of an output cable of the wind power generator. It should be noted that the various embodiments in the present specification are described in a progressive manner, each embodiment highlights differences from other embodiments, and the same or similar parts between the various embodiments can be understood with reference to each other.

The above description is merely illustrative of preferred embodiments of the present disclosure and is not intended to limit the present disclosure. It would be understood by those skilled in the art that various modifications and variations can be made to the present disclosure. Any modifications, equivalent alternatives, improvements and so on made within the spirit and principle of the present disclosure are to be included in the scope of protection of the present disclosure. It should be noted that similar reference numerals and letters refer to similar items in the following figures, and thus once an item is defined in one figure, it may not be further defined or explained in the following figures.

In the description of the present disclosure, it should be noted that orientation or positional relationships indicated by the terms such as “center”, “up”, “down”, “left”, “right”, “vertical”, “horizontal”, “inside”, and “outside” are the orientation or positional relationships shown based on the figures, or the orientation or positional relationships in which the inventive product is conventionally placed in use, and these terms are intended only to facilitate the description of the present disclosure and simplify the description, but not intended to indicate or imply that the referred devices or elements must be in a particular orientation or constructed or operated in the particular orientation, and therefore should not be construed as limiting the present disclosure. In addition, terms such as “first”, “second”, and “third” are used for distinguishing the description only, and should not be understood as an indication or implication of relative importance.

In the description of the present disclosure, it should also be noted that terms “disposed”, “mounted”, “coupled”, and “connected” should be understood broadly unless otherwise expressly specified or defined. For example, connection may be fixed connection or detachable connection or integral connection, may be mechanical connection or electric connection, or may be direct coupling or indirect coupling via an intermediate medium or internal communication between two elements. The above-mentioned terms could be understood by those of ordinary skill in the art according to specific situations.

1. A protection device for a subsea cable in an offshore wind farm, which comprises: a connecting flange, an intermediate pipe body, a tapered connecting pipe, and a connector,
wherein the connecting flange comprises a flange plate and a flange connecting pipe disposed on one side of a plane where the flange plate is located;
the connecting flange is connected to one end of the intermediate pipe body via the flange connecting pipe, and the other end of the intermediate pipe body is connected to the tapered connecting pipe via the connector; and
the connector is a pipe body having both ends opened, wherein one end of the connector is disposed inside the other end of the intermediate pipe body and fixedly connected to the intermediate pipe body, and the other end of the connector is disposed inside one end of the tapered connecting pipe and fixedly connected to the tapered connecting pipe.

2. The protection device for a subsea cable in an offshore wind farm according to claim 1, wherein one end of the flange connecting pipe remote from the flange plate has an outer diameter matching with an inner diameter of one end of the intermediate pipe body, and one end of the flange connecting pipe remote from the flange plate is disposed in one end of the intermediate pipe body and fixedly connected to the intermediate pipe body.

3. The protective device for a subsea cable in an offshore wind farm according to claim 2, wherein one end of the flange connecting pipe remote from the flange plate is provided with a plurality of first through holes, the intermediate pipe body is provided with second through holes matching with the first through holes, and the first through holes and the second through holes allow the connecting flange and the intermediate pipe body to be fixedly connected by a first fastener.

4. The protection device for a subsea cable in an offshore wind farm according to claim 3, wherein the first through holes are provided with screw threads, the first fastener comprises a plurality of first bolts and a first clip, the first clip is matched with a cross-section shape of the intermediate pipe body, the first clip is provided with through holes, and the first bolts are screwedly engaged with the first through holes and the second through holes to fix the first clip externally on the intermediate pipe body, so that the flange connecting pipe is fixedly connected to the intermediate pipe body.

5. The protection device for a subsea cable in an offshore wind farm according to claim 1, wherein the connector has one end provided with a plurality of third through holes, and the other end provided with a plurality of fourth through holes, the intermediate pipe body is provided with fifth through holes matching with the third through holes, and the third through holes and the fifth through holes allow the intermediate pipe body and the connector to be fixedly connected by a second fastener.

6. The protection device for a subsea cable in an offshore wind farm according to claim 5, wherein the tapered connecting pipe is provided with sixth through holes matching with the fourth through holes, and the fourth through holes and the sixth through holes allow the connector and the tapered connecting pipe to be fixedly connected by a third fastener.

7. The protection device for a subsea cable in an offshore wind farm according to claim 6, wherein the tapered connecting pipe comprises a cylindrical pipe portion and a tapered pipe portion, the tapered pipe portion comprises a large end portion and a small end portion, one end of the large end portion is connected to the cylindrical pipe portion, an inner diameter of the small end portion matches an outer diameter of a cable to be protected, and one end of the cylindrical pipe portion remote from the tapered pipe portion has an inner diameter matching with an outer diameter of the connector.

8. The protection device for a subsea cable in an offshore wind farm according to claim 7, wherein the sixth through holes are provided at one end of the cylindrical pipe portion remote from the tapered pipe portion.

9. The protection device for a subsea cable in an offshore wind farm according to claim 7, wherein the third through holes and the fourth through holes are provided with screw threads therein, the second fastener comprises a plurality of second bolts and a second clip, the second clip is matched with a cross-section shape of the intermediate pipe body, the second clip is provided with through holes, and the second bolts are screwedly engaged with the third through holes and the fifth through holes to fix the second clip externally on the intermediate pipe body, so that the intermediate pipe body is fixedly connected to the connector.

10. The protection device for a subsea cable in an offshore wind farm according to claim 9, wherein the third fastener comprises a plurality of third bolts and a plurality of third clips, the third clip is matched with a cross-section shape of the cylindrical pipe portion, the third clip is provided with through holes, and the third bolts are screwedly engaged with the fourth through holes and the sixth through holes to fix the third clip externally on the tapered connecting pipe, so that the connector is fixedly connected to the tapered connecting pipe.
